(19) United States
(12) Patent Application Publication
(10) Pub. No.: US 2018/0248781 A1
(43) Pub. Date: Aug. 30, 2018

(54) PROCESSING DATA TUPLES THAT HAVE MISSING DATA IN A STREAMING APPLICATION

(71) Applicant: International Business Machines Corporation, Armonk, NY (US)

(72) Inventors: Eric L. Barsness, Pine Island, MN (US); Daniel E. Beuch, Rochester, MN (US); Michael J. Branson, Rochester, MN (US); John M. Santosuosso, Rochester, MN (US)

(21) Appl. No.: 15/444,989

(22) Filed: Feb. 28, 2017

(51) Int. Cl. H04L 12/26; H04L 12/801; G06F 17/30

(52) U.S. Cl. CPC H04L 43/16; H04L 47/11; G06F 17/30516; G06F 17/30371; H04L 43/0852

(57) ABSTRACT

A streams manager includes a missing data mechanism that allows operators to forward data tuples that have missing derived data to a next operator in a streaming application. One or more new threads are created to continue processing the missing derived data. Once the processing for the missing derived data is complete, the derived data is reunited with the data tuple. The data tuple with missing derived data can travel until it reaches an operator that requires the missing derived data. The data tuple is then placed in a waiting area for the operator. Once the missing derived data is added to the data tuple in the waiting area, the data tuple can be processed by the operator that required the derived data.

### BACKGROUND

### 1. Technical Field

This disclosure generally relates to streaming applications, and more specifically relates to processing data tuples in streaming applications.

### 2. Background Art

Streaming applications are known in the art, and typically include multiple operators coupled together in a flow graph that process streaming data in near real-time. An operator typically takes in streaming data in the form of data tuples, operates on the data tuples in some fashion, and outputs the processed data tuples to the next operator. Streaming applications are becoming more common due to the high performance that can be achieved from near real-time processing of streaming data.

Streaming applications can be used to analyze data at very high rates. In some streaming applications, the flow rate of data tuples between operators can be in the hundreds of thousands or even millions of data tuples per second. Because data tuples stream from one operator to another in a streaming application, a delay in processing data tuples in one operator can negatively impact the performance of the streaming application, because the one operator becomes a bottleneck that restricts the availability of its data tuples to downstream operators. Various ways have been developed to improve performance of a streaming application that has a bottleneck. For example, if an operator becomes a bottleneck, it is known to create one or more operators that can process the data tuples in parallel with the operator that is a bottleneck, thereby relieving the bottleneck. The known methods of improving performance of a streaming application that has a bottleneck require all data to be present in a data tuple before the data tuple can be forwarded to the next operator for processing.

### BRIEF SUMMARY

A streams manager includes a missing data mechanism that allows operators to forward data tuples that have missing derived data to a next operator in a streaming application. One or more new threads are created to continue processing the missing derived data. Once the processing for the missing derived data is complete, the derived data is reunited with the data tuple. The data tuple with missing derived data can travel until it reaches an operator that requires the missing derived data. The data tuple is then placed in a waiting area for the operator. Once the missing derived data is added to the data tuple in the waiting area, the data tuple can be processed by the operator that required the derived data.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is a block diagram of a computer system that includes a missing data mechanism that can forward a data tuple that has missing data to a next operator;

FIG. 2 is a block diagram of one suitable implementation for the missing data mechanism shown in FIG. 2;

FIG. 3 is a table showing a first suitable implementation for a time limit for processing data tuples;

FIG. 4 is a table showing a second suitable implementation for a time limit that changes according to the number of tuples backed up;

FIG. 5 is a flow diagram of a method for an operator to output a tuple with missing data;

FIG. 6 is a flow diagram of a method for processing an input data tuple;

FIG. 7 is a flow diagram of a method for processing missing data in a tuple, and for adding the missing data to the incomplete tuple;

FIG. 8 is a sample streaming application for illustrating the concepts discussed herein;

FIG. 9 is a sample data tuple that includes four data elements D1, D2, D3 and D4;

FIG. 10 shows the processing of the data tuple in FIG. 9 by operators B, C and D in FIG. 8 in a first suitable example; and

FIG. 11 shows the processing of the data tuple in FIG. 9 by operators B, C and D in FIG. 8 in a second suitable example.

### DETAILED DESCRIPTION

The disclosure and claims herein are directed to a streams manager that includes a missing data mechanism that allows operators to forward data tuples that have missing derived data to a next operator in a streaming application. One or more new threads are created to continue processing the missing derived data. Once the processing for the missing derived data is complete, the derived data is reunited with the data tuple. The data tuple with missing derived data can travel until it reaches an operator that requires the missing derived data. The data tuple is then placed in a waiting area for the operator. Once the missing derived data is added to the data tuple in the waiting area, the data tuple can be processed by the operator that required the derived data.

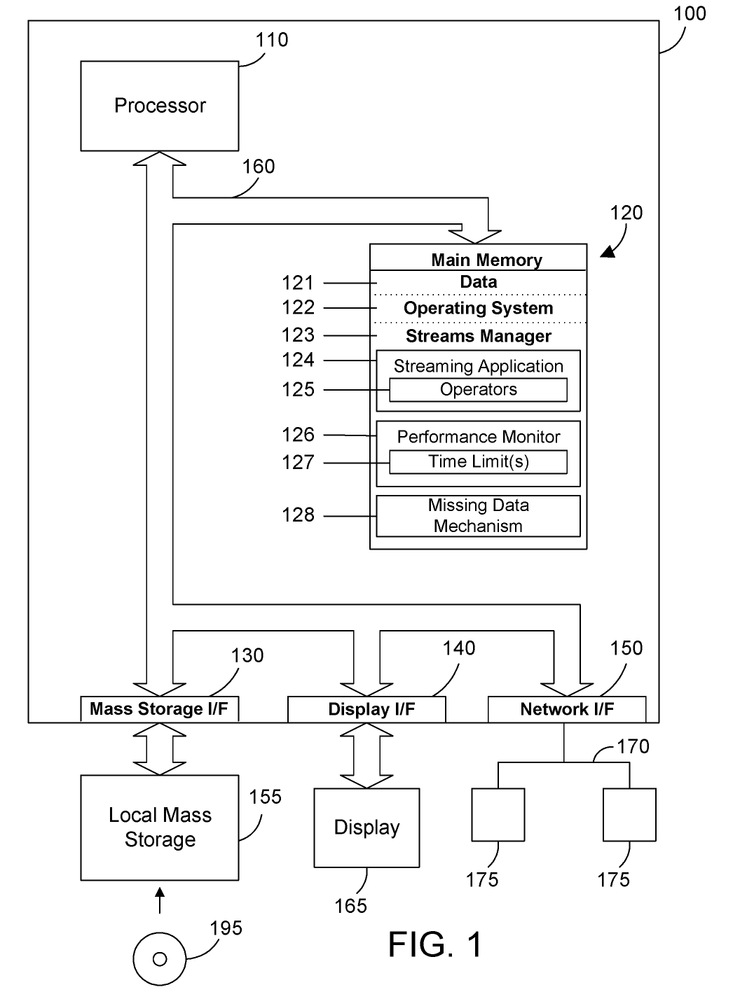

Referring to FIG. 1, a computer system 100 is one suitable implementation of a server computer system that includes a missing data mechanism as described in more detail below. Server computer system 100 is an IBM POWER8 computer system. However, those skilled in the art will appreciate that the disclosure herein applies equally to any computer system, regardless of whether the computer system is a complicated multi-user computing apparatus, a single user workstation, a laptop computer system, a tablet computer, a phone, or an embedded control system. As shown in FIG. 1, computer system 100 comprises one or more processors 110, a main memory 120, a mass storage interface 130, a display interface 140, and a network interface 150. These system components are interconnected through the use of a system bus 160. Mass storage interface 130 is used to connect mass storage devices, such as local mass storage device 155, to computer system 100. One specific type of local mass storage device 155 is a readable and writable CD-RW drive, which may store data to and read data from a CD-RW 195. Another suitable type of local mass storage device 155 is a card reader that receives a removable memory card, such as an SD card, and performs reads and writes to the removable memory. Yet another suitable type of local mass storage device 155 is a thumb drive.

Main memory 120 preferably contains data 121, an operating system 122, and a streams manager 123. Data 121 represents any data that serves as input to or output from any program in computer system 100. Operating system 122 is a multitasking operating system, such as AIX or LINUX. The streams manager 123 is software that provides a run-time environment that executes a streaming application 124. The streaming application 124 preferably comprises a flow graph that includes processing elements that include operators 125 that process data tuples. The streams manager 123 preferably includes a performance monitor 126 that monitors performance of one or more of the operators 125 in the streaming application. Performance monitor 126 may also monitor performance of groups of operators and/or of the entire streaming application 124. The performance monitor 126 functions according to one or more defined time limits 127. Time limit(s) 127 may include time limits for one or more operators to process data tuples. In the most preferred implementation, there is a time limit defined for operators in the flow graph that are selected to have a time limit according to any suitable criteria. For example, operators in a critical path for the streaming application could have corresponding time limits defined. It is also within the scope of the disclosure and claims herein to define a time limit for all operators 125 in the streaming application 124. Time limits can be defined for any of the operators 125, and a default time limit could then be applied to all other operators 125 that don't have a defined time limit. These and other variations are within the scope of the disclosure and claims herein.

The missing data mechanism 128 detects when one of the time limits 127 is exceeded, and determines whether the data tuple can be sent to the next operator with missing derived data. The function of the missing data mechanism 128 is discussed in detail below. While the time limits 127 are shown in the performance monitor 126 in FIG. 1, the time limits 127 could be part of the missing data mechanism 128. In addition, while the missing data mechanism 128 is shown in FIG. 1 as part of streams manager 123, one or more parts of the missing data mechanism 128 could be in one or more of the operators 125.

Computer system 100 utilizes well known virtual addressing mechanisms that allow the programs of computer system 100 to behave as if they only have access to a large, contiguous address space instead of access to multiple, smaller storage entities such as main memory 120 and local mass storage device 155. Therefore, while data 121, operating system 122, and streams manager 123 are shown to reside in main memory 120, those skilled in the art will recognize that these items are not necessarily all completely contained in main memory 120 at the same time. It should also be noted that the term “memory” is used herein generically to refer to the entire virtual memory of computer system 100, and may include the virtual memory of other computer systems coupled to computer system 100.

Processor 110 may be constructed from one or more microprocessors and/or integrated circuits. Processor 110 executes program instructions stored in main memory 120. Main memory 120 stores programs and data that processor 110 may access. When computer system 100 starts up, processor 110 initially executes the program instructions that make up operating system 122. Processor 110 also executes the streams manager 123, which executes the streaming application 124, which includes the missing data mechanism 128.

Although computer system 100 is shown to contain only a single processor and a single system bus, those skilled in the art will appreciate that a missing data mechanism as described herein may be practiced using a computer system that has multiple processors and/or multiple buses. In addition, the interfaces that are used preferably each include separate, fully programmed microprocessors that are used to off-load compute-intensive processing from processor 110. However, those skilled in the art will appreciate that these functions may be performed using I/O adapters as well.

Display interface 140 is used to directly connect one or more displays 165 to computer system 100. These displays 165, which may be non-intelligent (i.e., dumb) terminals or fully programmable workstations, are used to provide system administrators and users the ability to communicate with computer system 100. Note, however, that while display interface 140 is provided to support communication with one or more displays 165, computer system 100 does not necessarily require a display 165, because all needed interaction with users and other processes may occur via network interface 150.

Network interface 150 is used to connect computer system 100 to other computer systems or workstations 175 via network 170. Computer systems 175 represent computer systems that are connected to the computer system 100 via the network interface 150 in a computer cluster. Network interface 150 broadly represents any suitable way to interconnect electronic devices, regardless of whether the network 170 comprises present-day analog and/or digital techniques or via some networking mechanism of the future. Network interface 150 preferably includes a combination of hardware and software that allows communicating on the network 170. Software in the network interface 150 preferably includes a communication manager that manages communication with other computer systems 175 via network 170 using a suitable network protocol. Many different network protocols can be used to implement a network. These protocols are specialized computer programs that allow computers to communicate across a network. TCP/IP (Transmission Control Protocol/Internet Protocol) is an example of a suitable network protocol that may be used by the communication manager within the network interface 150. In one suitable implementation, the network interface 150 is a physical Ethernet adapter.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

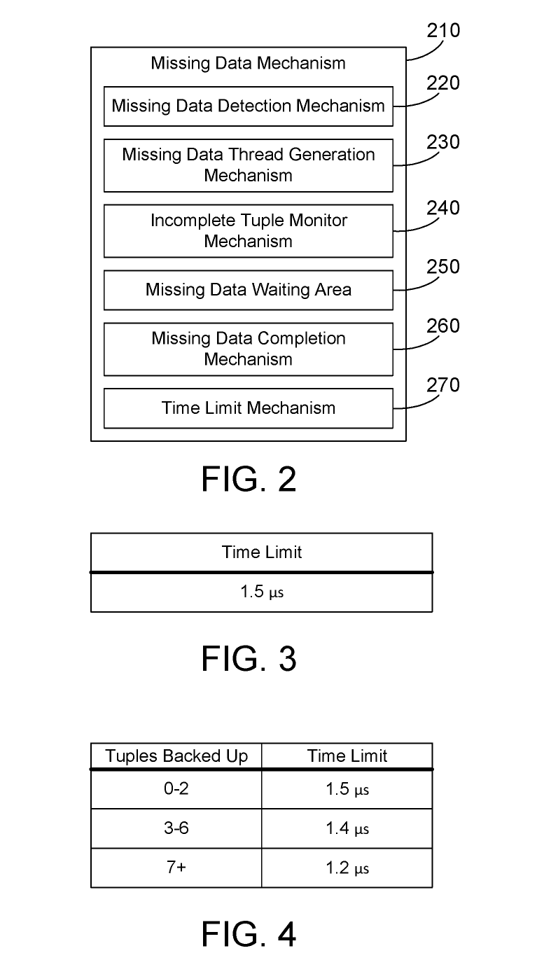

FIG. 2 shows a block diagram of a missing data mechanism 210 that is one suitable implementation for the missing data mechanism 128 shown in FIG. 1. The missing data mechanism 210 preferably includes a missing data detection mechanism 220, a missing data thread generation mechanism 230, an incomplete tuple monitor mechanism 240, a missing data waiting area 250, a missing data completion mechanism 260, and a time limit mechanism 270. The missing data detection mechanism 220 detects when a data tuple has missing data at a point in time when a time limit for processing the data tuple is exceeded. The missing data thread generation mechanism 230 generates one or more threads to processing the missing data asynchronously to the processing of data tuples in the streaming application. The incomplete tuple monitor mechanism 240 monitors the location in the flow graph of data tuples that have missing data. The missing data waiting area 250 is an area where data tuples are put while waiting for their missing data. In one specific implementation, there may be a missing data area corresponding to each operator in the flow graph. The missing data waiting area 250 could be in an operator, or could be separate from any operator. The missing data completion mechanism 260 determines when the new thread(s) complete processing of the missing data, determines the location of the incomplete data tuple in the flow graph using the incomplete tuple monitor mechanism 240, and adds the missing data to the incomplete data tuple to create a complete data tuple. When a data tuple with missing data is being processed by an operator, the missing data completion mechanism waits for the operator to finish processing the data tuple, then adds the missing data to the data tuple after the operator outputs the data tuple. When a data tuple with missing data is in a missing data waiting area 250, the missing data completion mechanism 260 adds the missing data to the data tuple, and submits the data tuple to the operator for processing. The time limit mechanism 270 detects when a time limit 127 for an operator has been exceeded.

The missing data detection mechanism 220 preferably performs its functions when a time limit for processing a data tuple in an operator is exceeded. Any suitable time limit could be used. For example, FIG. 3 shows a static time limit of 15 microseconds, which could be part of time limit(s) 127 shown in FIG. 1. This time limit could apply to all operators in a flow graph, to multiple operators in the flow graph, or to only one operator in the flow graph. The time limit can vary as a function of the tuples backed up, as shown in FIG. 4. When there are zero to two tuples backed up, the time limit is 15 microseconds. When there are three to six tuples backed up, the time limit is 14 microseconds. When there are seven or more tuples backed up, the time limit is 12 microseconds. A tuple is “backed up” if it is waiting to be processed by an operator. So an operator that has five tuples backed up means there are five other data tuples waiting to be processed as the operator is processing a data tuple. Here again, the time limits shown in FIG. 4 could apply to all operators in the flow graph, to multiple operators in the flow graph, or to only one operator in the flow graph. Thus, individual operators could have time limits that are different than other operators. In addition, the time limit could be expressed using an equation or any suitable heuristic. The disclosure and claims herein extend to any suitable time limit for an operator in a flow graph of a streaming application, however derived or expressed.

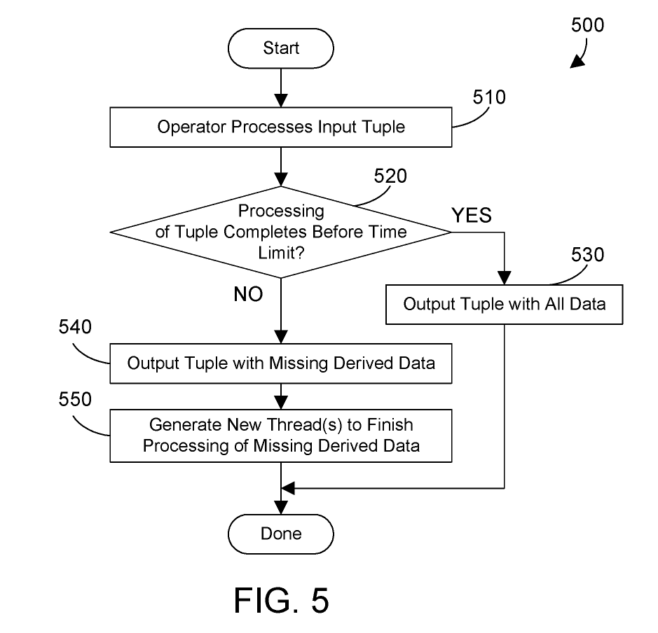

Referring to FIG. 5, a method 500 is preferably performed by the streams manager 123 shown in FIG. 1, with some parts performed by the missing data mechanism 128 shown in FIG. 1. An operator processes an input tuple (step 510). When the processing of the input tuple completes before the time limit for the operator (step 520=YES), the tuple is output with all its data (step 530), including the derived data generated by the operator. Step 520 is preferably performed by the time limit mechanism 270 shown in FIG. 2. As used herein, the term “derived data” means data that is changed or added by an operator. Thus, if an operator receives an input tuple with data {A, B, C, D, E} but the operator only updates data B and C, then B and C will be the derived data for that operator, while data A, D and E will pass through the operator without the operator processing A, D and E. When the processing of the data tuple does not complete before the time limit (step 520=NO), the tuple is output with missing derived data (step 540). One or more new threads are generated to finish processing of the missing derived data (step 550). The new threads can be generated by the missing data thread generation mechanism 230 in FIG. 2. The new thread(s) then process the missing derived data asynchronously to the processing of data tuples in the flow graph. Method 500 is then done. Method 500 shows that when a data tuple can be processed within the time limit, a complete data tuple with all its data is output. But when the processing of the data tuple exceeds the time limit, the data tuple can still be output with missing derived data.

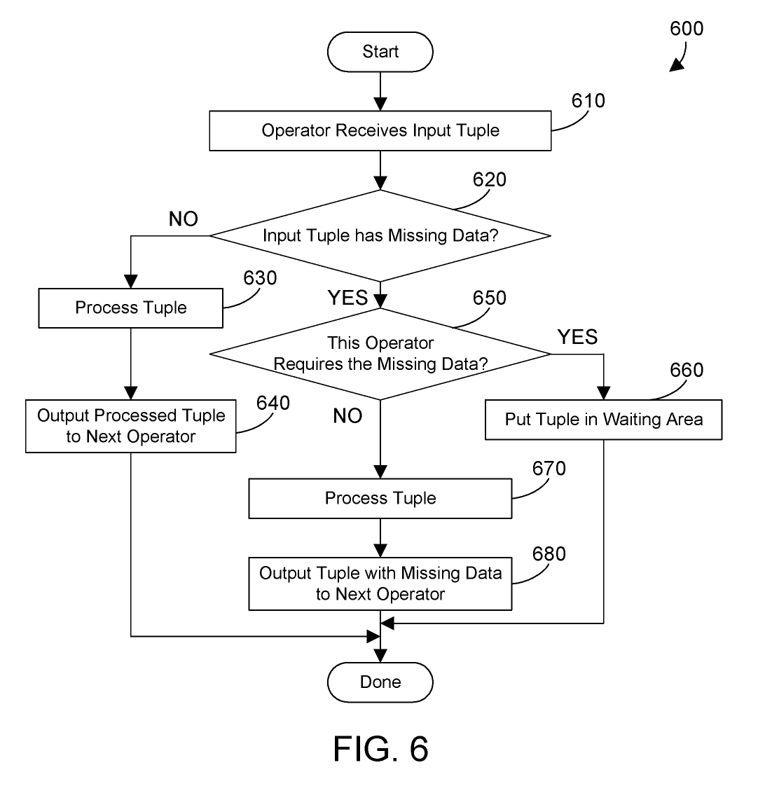

Referring to FIG. 6, a method 600 illustrates the processing of tuples by an operator in the flow graph. An operator receives an input data tuple (step 610). When the input data tuple is complete, meaning it has no missing data (step 620=NO), the tuple is processed (step 630) and the processed tuples is output to the next operator (step 640). Steps 640 and 640 in FIG. 6 could perform method 500 shown in FIG. 5. When the input tuple has missing data (step 620=YES), and this operator requires the missing data (step 650=YES), the data tuple is put in a waiting area (step 660) to await arrival of the missing derived data. When the operator does not require the missing derived data (step 650=NO), the operator processes the data tuple (step 670), and outputs the data tuple with the missing derived data to the next operator (step 680). Method 600 is then done. Method 600 illustrates that when an operator requires missing derived data, the tuple is put in a waiting area to await arrival of the missing data. But when the operator does not require the missing derived data, the operator can process the incomplete data tuple and pass the incomplete data tuple to the next operator for processing.

The missing data detection mechanism 220 in FIG. 2. can detect when the data tuple has missing data or not in step 620 in FIG. 6. The streams manager 123 can determine which operators require which data, which determines whether a particular operator requires the missing data in step 650. This is relatively straightforward to do at compile-time, and this information can be passed to the streams manager 123 so the streams manager can determine which operators in the flow graph require which data in the data tuple.

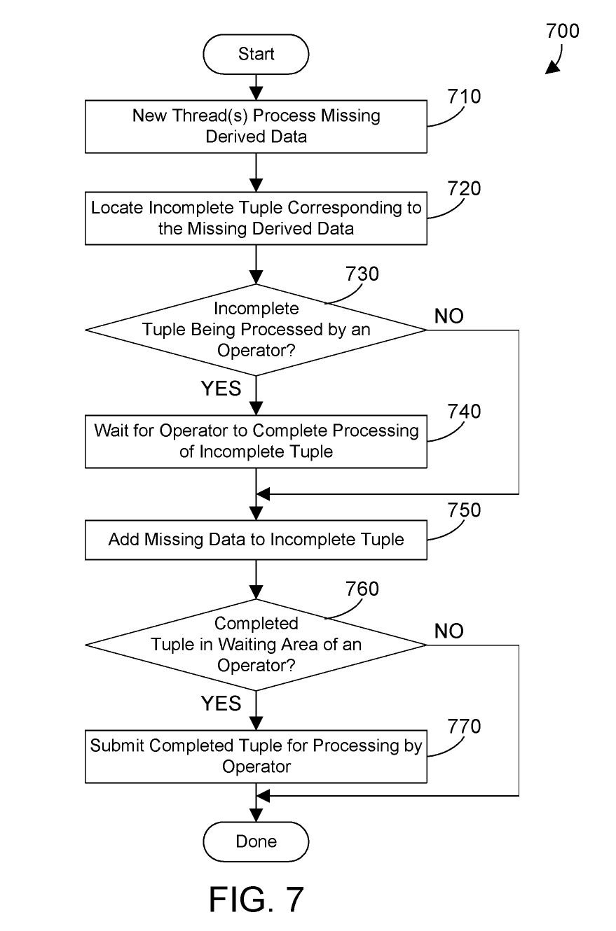

FIG. 7 is a flow diagram of a method 700 that is preferably performed by the missing data completion mechanism 260 in FIG. 2. The new thread(s) process the missing derived data (step 710). The incomplete tuple corresponding to the missing derived data is located (step 720). The location of the incomplete tuple is preferably tracked by the incomplete tuple monitor mechanism 240 shown in FIG. 2. When the incomplete tuple is being processed by an operator (step 730=YES), method 700 waits for the operator to complete the processing of the incomplete tuple (step 740), then adds the missing data to the incomplete tuple (step 750) after the operator outputs the incomplete tuple. When the incomplete tuple is not being processed by an operator (step 730=NO), the missing data is added to the incomplete tuple (step 750). When the completed tuple is in the waiting area of an operator (step 760=YES), the completed tuple is submitted for processing by the operator (step 770), and method 700 is done. When the completed tuple is not in the waiting area of an operator (step 760=NO), method 700 is done.

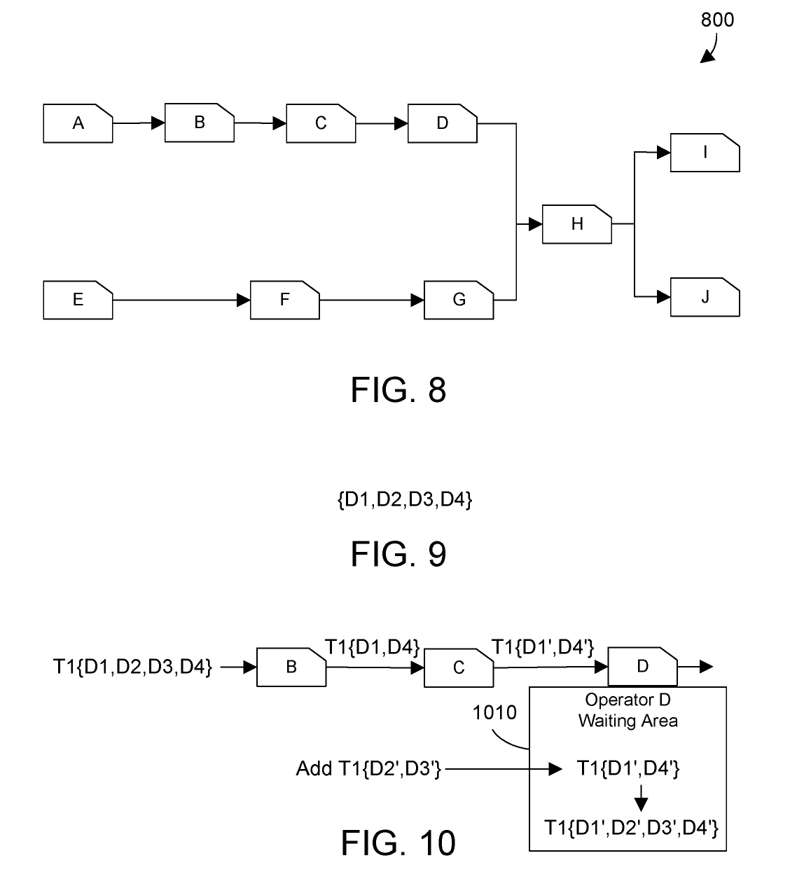

A simple example is now provided to more specifically illustrate some of the concepts discussed generally above. Referring to FIG. 8, an extremely simplified streaming application 800 is shown for the purposes of illustrating the concepts herein. The streaming application 800 includes ten operators A, B, C, D, E, F, G, H, I and J. Operator A produces data tuples that are sent to operator B. Operator B operates on the data tuples received from operator A and sends the resulting data tuples to operator C. Operator C operates on the data tuples received from operator B and sends the resulting data tuples to operator D. In similar fashion, operator E produces data tuples that are sent to operator F, which processes those data tuples and sends resulting data tuples to operator G. Operators D and G both send their data tuples to operator H, which processes these data tuples and sends some data tuples to operator I and other data tuples to operator J. We assume for this example each of the operators in the flow graph 800 in FIG. 8 operate on data tuples that have the format shown in FIG. 9, which includes four different data elements D1, D2, D3 and D4.

We now consider a part of the flow graph 800 in FIG. 8 to illustrate the concepts discussed above with respect to FIGS. 5-7. Referring to FIG. 10, we assume operator B receives a full data tuple T1 with all four data elements D1, D2, D3 and D4 from operator A. We assume for this example operator B processes data elements D2 and D3, and passes data elements D1 and D4 through without modification. Thus, D2 and D3 are derived values for operator B. We further assume for this example operator B processes tuple T1 (step 510 in FIG. 4), and cannot complete its processing of tuple T1 before the time limit for operator B expires (step 520=NO in FIG. 5), meaning it cannot generate the derived values D2 and D3 before the time limit for operator B expires. Operator B then outputs tuple T1 with missing derived data (step 540 in FIG. 5) to operator C (step 540, FIG. 5). This is shown in FIG. 10 by tuple T1 output from operator B having data elements D1 and D4 while missing data elements D2 and D3. One or more new threads are generated to finish the processing of the missing derived data (step 550, FIG. 5).

We now assume the incomplete tuple T1{D1,D4} is input to operator C (step 610 and 620=YES, FIG. 6). We further assume operator C operates on (or derives) data elements D1 and D4, but does not operate on (or derive) elements D2 and D3. This means operator C does not require either of the missing data elements D2 or D3 (step 650=NO). Operator C then processes the incomplete tuple (step 670) and outputs the tuple with the missing data to operator D (step 680, FIG. 6). This is shown in FIG. 10 by tuple T1 output from operator C having data elements D1′ and D4′ while missing data elements D2 and D3. Note the D1′ and D4′ are the derived values for D1 and D4 caused by operator C processing the input tuple T1{D1,D4}.

Next, we assume the incomplete tuple T1{D1′,D4′} is input to operator D (step 610 and 620=YES, FIG. 6). We further assume for this example operator D operates on (or derives) data element D2, but does not operate on (or derive) data elements D1, D3 or D4. Operator D requires data element D2, which is missing (step 650=YES), so the data tuple T1{D1′,D4′} is placed in the waiting area for operator D (step 660), as shown in FIG. 10, to await the arrival of the missing data. Asynchronously to the processing of data tuples by the operators in the flow graph, the one or more new threads that were generated in step 550 in FIG. 5 generate the missing derived data (step 710, FIG. 7). Once the missing derived data is generated, the incomplete tuple corresponding to the missing derived data is located (step 720, FIG. 7). In this example, the incomplete tuple T1{D1′,D4′} is in the waiting area for operator D (step 730=NO), so the missing derived data is added to the incomplete data tuple (step 750, FIG. 7), as shown in FIG. 10 by Add T1{D2′,D3′} to the incomplete tuple T1{D1′,D4′} in the operator D waiting area. The result is a complete tuple T1 with all four data elements D1′, D2′, D3′ and D4′, as shown in the operator D waiting area in FIG. 10. The completed tuple is in the waiting area of operator D (step 760=YES, FIG. 7), so the completed tuple T1{D1′,D2′,D3′,D4′} is submitted to operator D for processing (step 770, FIG. 7). This first example assumes the incomplete tuple T1{D1′,D4′} is stored in the waiting area for operator D before the new thread(s) generate the missing derived data D2′ and D3′.

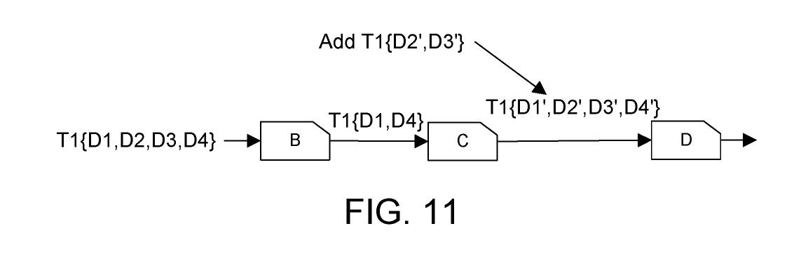

In a second example shown in FIG. 11, we assume tuple T1{D1,D2,D3,D4} is processed by operator B, with the same result shown in FIG. 10, namely, that operator B cannot complete the processing of data tuple T1 before the time limit, and as a result, the incomplete tuple T1{D1,D4} is output to operator C. We assume for this second example the new thread(s) generate the missing derived data D2′ and D3′ while operator C is processing the incomplete data tuple T1{D1,D4} (step 730=YES). Operator C completes its processing of the incomplete tuple T1{D1,D4} (step 740, FIG. 7), and then outputs the processed tuple T1{D1′,D4′} to operator D. Once the incomplete tuple T1{D1′,D4′} is output from operator C, the missing derived data D2′ and D3′ is added to the incomplete tuple (step 750, FIG. 7), as shown by the Add T1{D2′,D3′} in FIG. 11, resulting in a full data tuple T1{D1′,D2′,D3′,D4′} being input to operator D.

In the examples shown in FIGS. 10 and 11, the missing derived data is shown by simply not including the indicator for the missing derived data in the tuple. Missing data in a data tuple can be indicated in any suitable way. For example, the absence of data can indicate missing data. In one alternative, metadata for the tuple can indicate which data in the tuple is valid and which is missing. In another alternative, a special data value could be defined that indicates missing data, and a tuple with missing data will include the special data value that indicates the missing data. Of course, any suitable method for indicating missing data in a data tuple could be used within the scope of the disclosure and claims herein.

The examples above are extremely simplified to illustrate the generate concepts herein. One skilled in the art will appreciate that many variations are possible within the scope of the disclosure and claims herein. For example, an incomplete tuple could be processed by many different operators that do not require any of the missing derived data. The waiting area for incomplete tuples could be within an operator or could be separate from an operator. In one particular implementation, the streams manager could define a waiting area for each operator in the flow graph separate from the operators. The mechanisms shown in the missing data mechanism 210 in FIG. 2 could reside in the streams manager, in an operator, or in any combination of the two. These and other variations are within the scope of the disclosure and claims herein.

In the discussion herein, data tuples are sometimes referred to as data tuples, and at other times are referred to as tuples. These are deemed to be equivalent terms, as the tuples discussed herein are data tuples in a streaming application.

A streams manager includes a missing data mechanism that allows operators to forward data tuples that have missing derived data to a next operator in a streaming application. One or more new threads are created to continue processing the missing derived data. Once the processing for the missing derived data is complete, the derived data is reunited with the data tuple. The data tuple with missing derived data can travel until it reaches an operator that requires the missing derived data. The data tuple is then placed in a waiting area for the operator. Once the missing derived data is added to the data tuple in the waiting area, the data tuple can be processed by the operator that required the derived data.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. An apparatus comprising:
at least one processor;
a memory coupled to the at least one processor;
a streams manager residing in the memory and executed by the at least one processor, the streams manager executing a streaming application that comprises a flow graph that includes a plurality of operators that process a plurality of data tuples; and
a missing data mechanism that detects when a first of the plurality of operators exceeds a specified time limit for processing a selected data tuple, and in response, forwards the selected data tuple with missing derived data to a second operator.

2. The apparatus of claim 1 wherein the missing data mechanism causes the generation of at least one new thread for processing the derived data.

3. The apparatus of claim 2 wherein the missing data mechanism detects when the at least one new thread completes the processing of the derived data, and in response, locates the selected data tuple in the flow graph, and adds the derived data to the selected data tuple.

4. The apparatus of claim 2 wherein the at least one new thread completes processing of the derived data asynchronously to the processing of data tuples by the plurality of operators in the streaming application.

5. The apparatus of claim 3 wherein, when the selected data tuple is located in a waiting area of a third operator, after the derived data is added to the selected data tuple, the selected data tuple is submitted for processing by the third operator.

6. The apparatus of claim 3 wherein, when the missing data mechanism locates the selected data tuple with the missing derived data in the flow graph, and the selected data tuple with the missing derived data is being processed by a fourth operator, the missing data mechanism waits until the fourth operator outputs the selected data tuple with the missing derived data before adding the derived data to the selected data tuple.

7. The apparatus in claim 1 wherein, when a fifth operator that does not require the derived data receives the selected data tuple with the missing derived data, the fifth operator processes the selected data tuple with the missing derived data and outputs the selected data tuple with the missing derived data to a sixth operator.

8. The apparatus in claim 1 wherein, when a seventh operator that requires the derived data receives the selected data tuple with the missing derived data, the seventh operator puts the selected data tuple into a waiting area to await arrival of the derived data.

9. The apparatus of claim 1 wherein the selected data tuple with the missing derived data comprises an indication of the derived data that is missing.

10. A computer-implemented method executed by at least one processor for running streaming applications, the method comprising:
executing a streams manager that executes a streaming application that comprises a flow graph that includes a plurality of processing elements that process a plurality of data tuples; and
detecting when a first of the plurality of operators exceeds a specified time limit for processing a selected data tuple, and in response, forwarding the selected data tuple with missing derived data to a second operator.

11. The method of claim 10 further comprising generating at least one new thread for processing the derived data.

12. The method of claim 11 further comprising detecting when the at least one new thread completes the processing of the derived data, and in response, locating the selected data tuple in the flow graph, and adding the derived data to the selected data tuple.

13. The method of claim 11 further comprising the at least one new thread completing processing of the derived data asynchronously to the processing of data tuples by the plurality of operators in the streaming application.

14. The method of claim 12 wherein, when the selected data tuple is located in a waiting area of a third operator, after adding the derived data to the selected data tuple, submitting the selected data tuple for processing by the third operator.

15. The method of claim 12 wherein, when the selected data tuple with the missing derived data is located in the flow graph, and the selected data tuple with the missing derived data is being processed by a fourth operator, waiting until the fourth operator outputs the selected data tuple with the missing derived data before adding the derived data to the selected data tuple.

16. The method in claim 10 wherein, when a fifth operator that does not require the derived data receives the selected data tuple with the missing derived data, the fifth operator processing the selected data tuple with the missing derived data and outputting the selected data tuple with the missing derived data to a sixth operator.

17. The method in claim 10 wherein, when a seventh operator that requires the derived data receives the selected data tuple with the missing derived data, the seventh operator putting the selected data tuple into a waiting area to await arrival of the derived data.

18. The method of claim 10 wherein the selected data tuple with the missing derived data comprises an indication of the derived data that is missing.

19. A computer-implemented method executed by at least one processor for running streaming applications, the method comprising:
executing a streams manager that executes a streaming application that comprises a flow graph that includes a plurality of processing elements that process a plurality of data tuples;
detecting when a first of the plurality of operators exceeds a specified time limit for processing a selected data tuple, and in response:
forwarding the selected data tuple with missing derived data to a second operator that does not require the derived data, wherein the selected data tuple with the missing derived data comprises an indication of the derived data that is missing;
generating at least one new thread for processing the derived data asynchronously to the processing of data tuples by the plurality of operators in the streaming application;
the second operator processing the selected data tuple with the missing derived data and outputting the selected data tuple with the missing derived data to a third operator that requires the derived data;
putting the selected data tuple with the missing derived data into a waiting area to await arrival of the derived data;
detecting when the at least one new thread completes the processing of the derived data, and in response, locating the selected data tuple in the waiting area;
adding the derived data to the selected data tuple in the waiting area; and
submitting the selected data tuple for processing by the third operator.
